(19) United States
(12) Patent Application Publication
(10) Pub. No.: US 2020/0049103 A1
(43) Pub. Date: Feb. 13, 2020

(54) Aerospike Rocket Engine

(71) Applicants: Christopher Craddock, New York, NY (US); Donald Platt, Melbourne, FL (US)

(72) Inventors: Christopher Craddock, New York, NY (US); Donald Platt, Melbourne, FL (US)

(21) Appl. No.: 16/457,813

(22) Filed: Jun. 28, 2019

Related U.S. Application Data
(60) Provisional application No. 62/691,839, filed on Jun. 29, 2018.

(51) Int. Cl. F02K 1/52; F02K 1/78

(52) U.S. Cl. CPC F02K 1/52; F02K 1/78

(57) ABSTRACT

An aerospike rocket, engine having individually throttleable thrusters arranged in an annular ring around an aerospike, and a bi-propellant system having a catalyst system for combining a solid propellant and a hydrocarbon fuel, and an additional convergent-divergent flow for each thruster which combine into a main combustion chamber for the aerospike.

### PRIORITY

This application claims priority of U.S. Provisional Application Ser. No. 62/691,839, having a filing date of Jun. 29, 2018, the entire contents of which are all relied upon and fully incorporated herein by reference.

### FIELD OF THE INVENTION

The field of invention relates to the design and development of a rocket engine nozzles, and more specifically the present invention relates to the design and development process of an aerospike rocket engine nozzle, and further relates to improvements to aid in the creation of a more lightweight, reliable, efficient, and cost-effective aerospike rocket engine.

### BACKGROUND OF THE INVENTION

Conventional rocket engine technologies typically utilize chemical combustion in single and multistage engines to reach the upper atmosphere. The weight of the fuel and efficiency of the engine at varying altitudes often dictate current designs. In certain multistage rockets designed for orbit, when the first stage of a rocket ignites, the engine, which may be more efficient at lower altitudes, causes the rocket to lift into the atmosphere gradually, and thereafter the first stage separates from the upper stage and ignites a subsequent engine, which may be more effective at higher altitudes. The upper or second stage may be needed to enable a payload to reach the earth's lower orbit. A more efficient, lighter, and more cost-effective design is needed.

Conventional rocket engine technologies often utilize a convergent-divergent nozzle, such as a bell nozzle, which converts the heat of an exhausting flue gas into pressure (or thrust). Preferably in designing such a nozzle, the pressure of the resulting exhaust is provided to be about the same pressure as the atmosphere into which the exhaust exits. In an over-expanded nozzle, the atmospheric pressure is higher than the exhaust; the result is the opposite in an under-expanded nozzle. However, in an over-expanded state, and under-expanded state, the engine does not provide optimal efficiency for conversion of fuel to thrust. Accordingly, given typical environmental constraints, designers of bell nozzles attempt to provide the best physical configuration for the bell nozzle in order to allow an optimal thrust for an expanded fuel mixture over a range of altitudes and atmospheric pressures that are anticipated. The bell nozzle may be under-, over-, or ideally-expanded during an ascent of a flight profile, however the inefficiency is a trade-off for single configuration of the nozzle for the desired engine and fuel type. See FIG. 1. Figure shows basic isentropic conceptual relations where fuel and oxidizer are introduced in an injector, are combusted in a combustion chamber, and exited through an aperture to an outward expanding bell nozzle at various altitudes and atmospheric pressures.

An aerospike engine is an alternative design utilizing an aerospike nozzle rather than a bell nozzle. Designs of aerospike nozzles can vary, and include annular and linear versions. See FIG. 2, which shows a comparison between portions of an aerospike engine and portions of a bell-nozzle engine.

Several aerospike engines were tested from 1997 to 2000. because of technical problems, inherent constraints of the physical systems and materials, and high costs, the tests were discontinued. Among earlier attempts, the X-33 vehicle, a half scale demonstrator for the proposed “Venture Star” orbital space plane, utilized a prototype aerospike engine, and attempted to address certain expected issues with new technologies to be employed, among other things metallic thermal protection systems, and cryogenic fuel tanks for liquid hydrogen.

More specifically, the engine that was utilized, the prototype XRS-2200, was a linear aerospike research engine that included 20 combustion chambers, 10 aligned on each end of a ramp center body, which was developed by NASA and Rocketdyne. Liquid hydrogen and liquid oxygen were used with existing cooling systems—which design choice provided a significant thrust, but imposed also certain limitations. See FIG. 2. Following the failure of the tested technologies, further efforts were canceled.

Other experimental attempts have also failed. For example, attempts to develop an annular aerospike nozzle have not met with success. Among other things, erosion of the nozzle support, nozzle ablation, and cooling issues have been among the difficulties presented. Accordingly, aerospike technology is more difficult to deploy than conventional engines which use a bell nozzle because of design, development and fabrication, and other things.

While an aerospike engine is an alternative design intended to permit a space craft to leave the atmosphere while maintaining thrust efficiency from ground level to the upper reaches of the engine and, theoretically, aerospike engines also provide other advantages over traditional bell nozzle designs, nevertheless design complexities, reliance upon traditional techniques and conventional fuel types, and limited test data, among other things have hindered advances in this type of engine.

Accordingly, there has been a long-felt need to an improved aerospike nozzle engine design, and process which addresses the aforesaid problems and provides a more efficient, effective, lighter, and more cost-effective design; as well as the process for designing the parameters thereof to satisfy mission requirements.

### SUMMARY OF THE INVENTION

The instant invention relates to an aerospike rocket engine system comprising an exhaust control spike, and thrusters arranged in an annular ring. Each of the thrusters have a combustion chamber with an exhaust aperture directed toward an aerospike. The exhaust thruster apertures are arranged an annular ring around the exhaust control spike. In addition, a fuel system and catalyst system are provided for combining a bi-propellant fuel-catalyst mixture to power the thrusters.

In addition, a fuel and catalyst control system is provided for controlling flow of a fuel and a catalyst.

The exhaust control spike can be truncated, as a plug, or pointed as a spike, and alternative can be formed as a conical asymmetric widening tube for receiving an additional thrust from a turbine engine to complement a cluster of thrusters or cell nozzles.

In addition, a catalyst system can be provided with at least one flow constrictor means and/or separator such as a spreader plate, and orifice plate, a thrust ring, or a stainless steel screen.

The orifice plate can be adapted for providing a convergent region and divergent region, for accentuating the fuel exhaust into a combustion chamber for the aerospike.

It is to be understood that both the foregoing description and the following description are exemplary and explanatory only and are not restrictive of the invention, as claimed. Specific examples are included in the following description for purposes of clarity, but various details can be changed within the scope of the present invention.

### BRIEF DESCRIPTION OF THE DRAWINGS

A preferred embodiment of the invention has been chosen for detailed description to enable those having ordinary skill in the art to which the invention appertains to readily understand how to construct and use the invention and is shown in the accompanying drawing in which:

FIG. 1 is perspective view depicting examples of traditional bell nozzle.

FIG. 2 is a diagram of a traditional bell and an aerospike rocket engine.

FIG. 3 is a diagram comparison of the exhaust plume from a traditional bell nozzle and from an aerospike nozzle.

FIG. 4 is a perspective view of an image of one embodiment of an aerospike nozzle according to the invention.

FIG. 5A is a conceptual diagram of one embodiment of an aerospike engine according to the invention.

FIG. 5B is a conceptual diagram of one embodiment of an aerospike engine according to the invention.

FIG. 6 is a computer generated image of a perspective and side view of an embodiment of a aerospike component for an aerospike engine according to the invention.

FIG. 7 is a conceptual drawing of a side view of an embodiment of a aerospike component for an aerospike engine according to the invention.

FIG. 8 is an image showing a side perspective view and a top perspective view of an embodiment of an aerospike nozzle according to the invention including a needle spike.

FIG. 9 is a conceptual drawing showing a side view of an embodiment of portion of an embodiment of an aerospike engine according to the invention.

FIG. 10 is a conceptual drawing showing a side view of a portion of an embodiment of an aerospike engine according to the invention, including a portion of a combustion chamber and nozzle for at least one thruster.

FIG. 11 is a conceptual diagram of a portion of an embodiment of an aerospike engine according to the invention, including an embodiment of a catalyst package according to the invention.

FIG. 12 is a conceptual diagram of a portion of an embodiment of an aerospike engine according to the invention, including a further embodiment of a catalyst package according to the invention.

FIG. 13 is a conceptual diagram of a portion of an embodiment of an aerospike engine according to the invention, including an embodiment of a catalyst package and at least one thruster.

FIG. 14 is a conceptual diagram of a portion of an embodiment of an aerospike engine according to the invention, including a further embodiment of a catalyst package.

FIG. 15 is a conceptual diagram of a portion of an alternative embodiment of an aerospike engine adapted for a turbine engine or turbofan.

FIG. 16A-FIG. 16D are conceptual diagrams of a portion of an alternative embodiment of an aerospike engine according to the invention, including a further embodiment of a catalyst package.

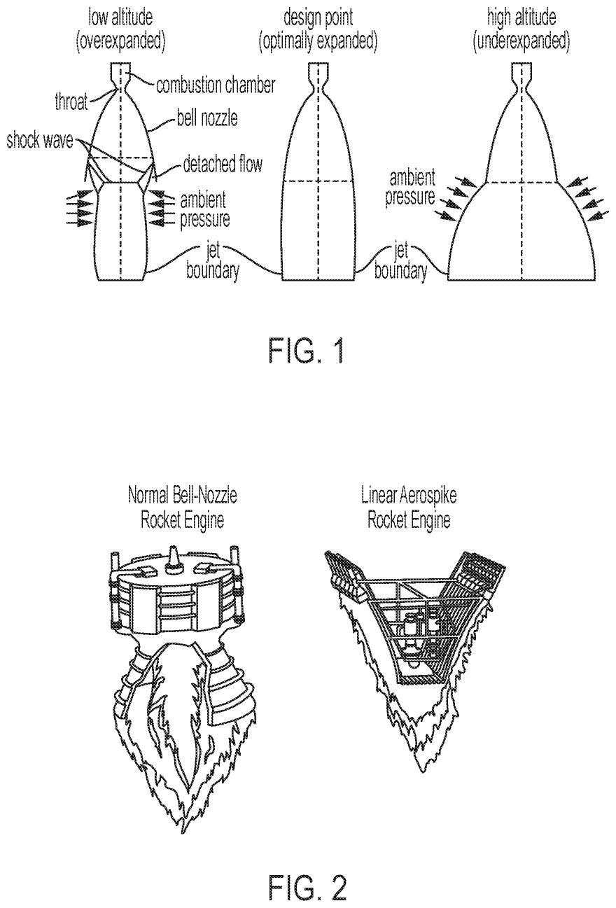

The above referenced figures are not to scale, and are for reference only in assisting the reader in understanding the invention in conjunction with the detailed written description which follows.

### DETAILED DESCRIPTION OF THE INVENTION

An aerospike rocket engine according to the invention is herein provided with a particular nozzle and combustion system which addresses the drawbacks and inefficiencies that have heretofore hindered the development of this aerospace engine technology.

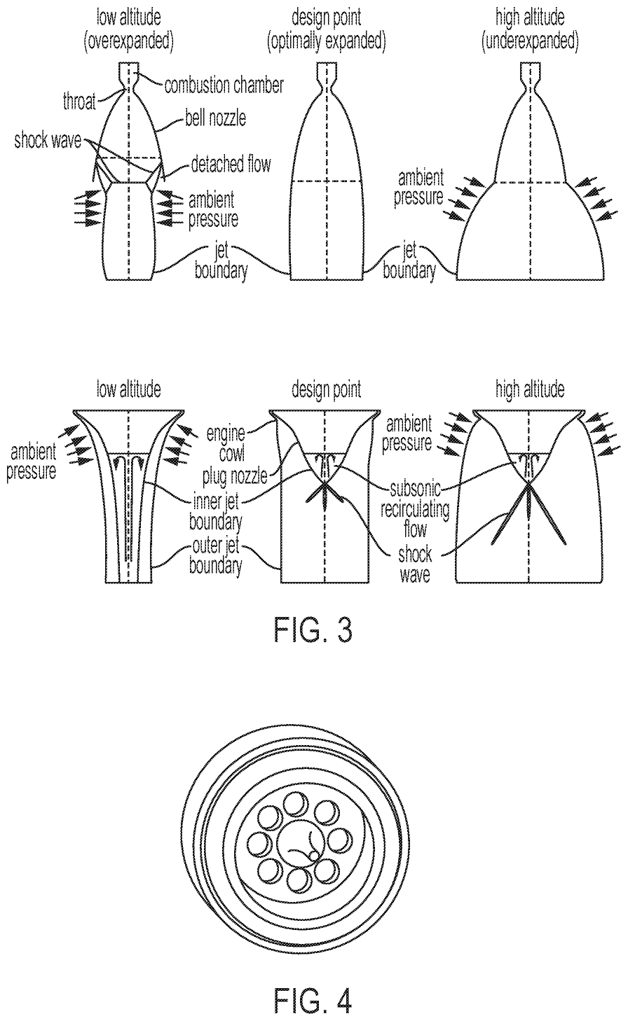

A significant difficulty in developing an efficient aerospike engine is the complex flow field it provides over varying conditions such as altitude. At low altitudes the plume structure of the jet exhaust is separated at its base and is called “open wake mode”. For higher altitudes, the converse is true, where the ambient pressure is low, the base flow field becomes closed, closing the wake, where base pressure is constant. See FIG. 3.

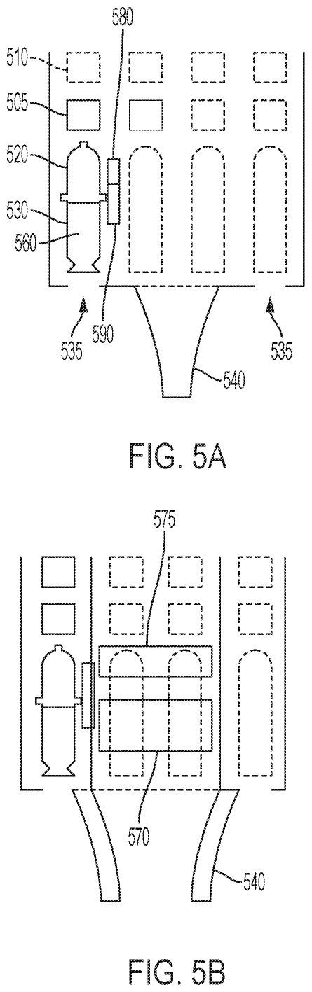

Referring to the drawings, FIGS. 4 AND 5A illustrate a preferred embodiment of system according to the invention in a conceptual diagram of component parts described more thoroughly herein. Specifically, in FIG. 4, a miniaturized embodiment of an aerospike engine 500 according to the invention is shown. In FIG. 5, an aerospike engine 500 according to the invention includes a fuel system 505, a catalyst system 520, a fuel and catalyst control system 510, at least one thruster 530; each of which having a nozzle 550, and one or more combustion chambers 560; and an exhaust control spike 540.

More specifically, as shown in FIG. 5A, a plurality of thrusters 530 can be arranged around the exhaust control spike 540. In one embodiment, the thrusters 530 are arranged in a circular configuration whereby, when in operation, each thruster provide an exhaust and the combined exhaust from the thrusters cooperate with the exhaust control spike to provide a combined thrust. One benefit of this arrangement is that the thrusters can be individually controlled to provide directional thrust.

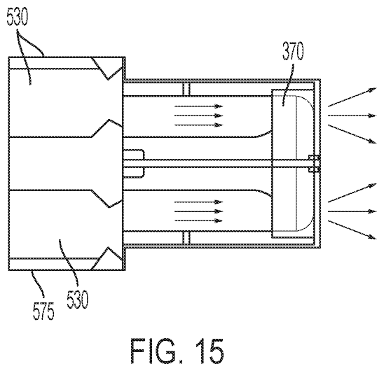

In a further embodiment, as shown in FIG. 5B, a plurality of thrusters 530 can be arranged around and exhaust control spike 540 having an internal aperture to receive an exhaust from a turbine system 570. It can be appreciated by person of ordinary skill in the art that the turbine system 570 includes conventional components found in existing turbine systems, and can include a separate turbine power system 575 for providing an independent combustion source for powering the turbine system 570. Alternatively, it can also be appreciated that one or more thrusters 530 can be provided with a shunt and valve control for shunting exhaust from the one or more thrusters 532 power the turbine system 570. A further embodiment utilizing this one or more thrusters 530 with a turbine engine 570 is also shown in FIG. 15 and described below.

In a preferred embodiment, the system is adapted for use with a fuel such as kerosene (RP-1) and one or more types of catalysts, such as hydrogen peroxide and potassium permanganate. A benefit of such choice of fuels and catalysts are safety and cost. These substances can be used at room temperature, avoiding complicated fuel cooling systems, and provide a greater margin of safety and simplicity than traditional fuel choices, such as liquid hydrogen and liquid oxygen, which are highly volatile and reactive, and thus difficult to maintain.

Accordingly, a fuel system 505 includes a fuel container for containing the fuel, such as kerosene, and other components for use with the aerospike engine system adapted for the particular mission parameters, such as a fuel control valve, as can be appreciated by a person of ordinary skill in the field of the invention. The fuel system is operatively connected to the catalyst system 520 for combination of the fuel and catalyst, which combination is controlled by the fuel and catalyst control system 510. It can be appreciated by persons of ordinary skill in the art that electrical, hydraulic, and fuel lines (not shown) can be provided.

In aerospike engine system 500 can also include one or more additional systems, depending on mission requirements, including an additional or alternative fuel type, an ignition system, a thermal protection system, a pre-burner, fuel inlet, fuel pump, cryo-control system, and heat exchanger, among other things. It can be appreciated by a person of ordinary skill in the art of rocket engine design, when and how such various components are used and their functions.

An aerospike engine system 500 according to the invention can also include one or more additional systems, depending on mission requirements, including an intermediate catalyst control system 590, a fuel and catalyst mixture control system 580, a turbine system 570, as further described herein. More particular description of certain components will follow.

Fabrication of an aerospike engine includes choosing lightweight materials that can perform under the rigors of the rocket engine and can include SiC or SiC composite for composition of the spike, which have good heat resistant characteristics. Titanium 6-4 has also good characteristics.

In addition, cooling of engine parts, such as by providing cooling channels, should be provided. Other high-performance materials such as organic matrix composition copper alloy (OMC) have been used for use in combustion chambers, whereas other structural support materials can be fabricated from stainless steel alloy.

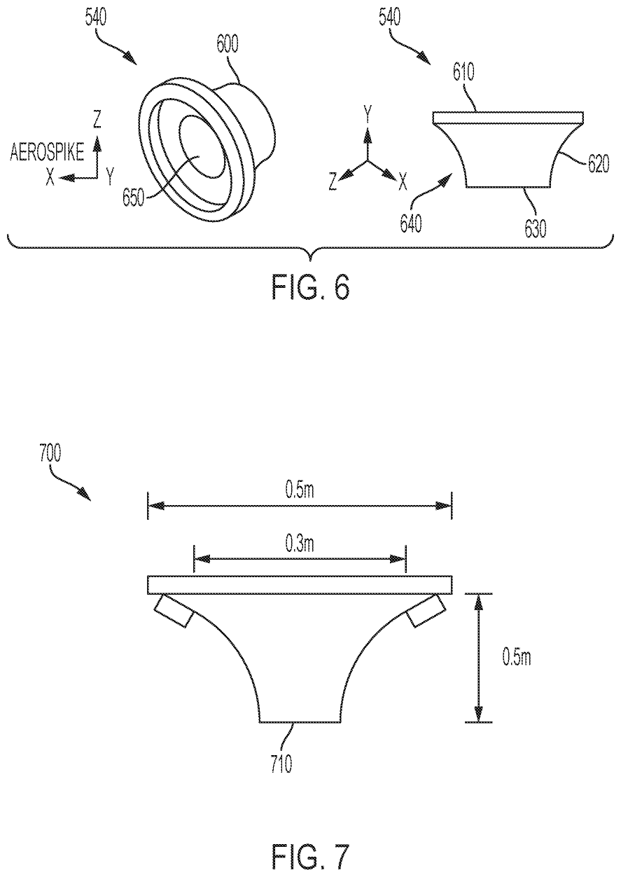

As shown in FIG. 6, in one embodiment, an exhaust control spike 540 (also referred to as “aerospike” or “aerospike nozzle” or “plug nozzle”) is provided as an annular aerospike 600. The annular aerospike can be generally characterized by having a base portion 610, a tapered neck portion 620, and a tip or end portion 630. It can be appreciated by a person of ordinary skill in the art that the aerospike can be linear or conical. In one embodiment of an aerospike for use with an engine according to the invention, the exhaust control spike 540 has an annular shape that tapers to an annular plug having a generally concentric exhaust aperture 650 extending from the base to its end, such as shown in FIG. 6. Alternatively, as shown in FIG. 7, an alternative embodiment of an exhaust control spike 540 can be provided having a conical aerospike 700 which tapers to a solid plug 710.

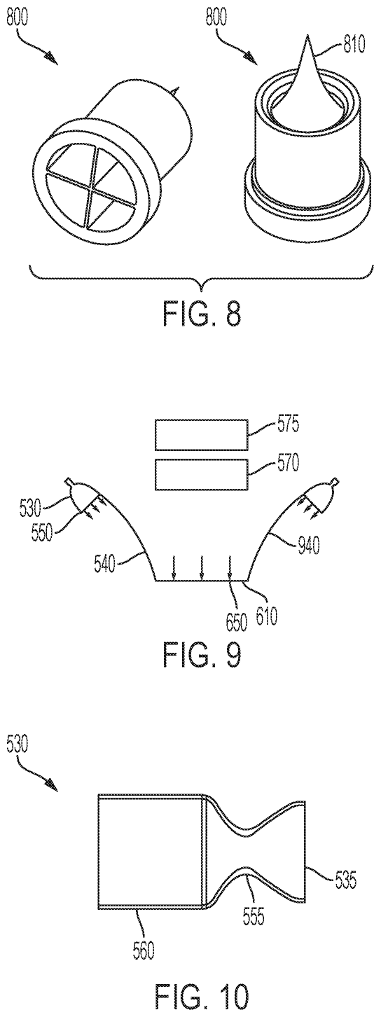

As shown in FIGS. 5A, and 5B, a plug type control spike is provided wherein the spike is truncated, and in an alternative embodiment, such as shown in FIG. 8, the exhaust control spike 540, is provided as a conical needle aerospike 800 and is not truncated, but forms a sharp spike or needle 810. The embodiment shown in FIG. 8 can be provided with a single combustion chamber or a plurality of partitioned combustion chambers to receive a plurality of exhausts from multiple thrusters 530. In alternative embodiments, the exhaust control spike can also be provided with a throat insert and spike rod.

It can be appreciated by a person of skill in the art of aerospike engine design that several parameters play important role in the design of an aerospike engine. The type of nozzle, whether it is linear, annular or tile shaped, as well as the nozzle contour, thrust performance factors, and flow field are important considerations.

An aerospike according to the invention utilizes aspects of a plug nozzle and has a conical shape with a curved and pointed spike. The gradual conical base to spike shape allows the exhaust gases to expand through an isentropic or constant entropy process. Accordingly, the nozzle's efficiency is maximized and little or no energy is lost as a consequence of the turbulent mixing of exhaust flow. Theoretically the curved spike must be of infinite length for ideal implementation, but this is not possible. There is a trade-off between the form of the exhaust plume and aspects of the physical means of boundary constraint imposed by the spike. It has an inner boundary, and can be described as a radial “in-flow” type of nozzle, meaning the expansion of the outward flow is towards the nozzle axis. There is also a secondary flow circulation which looks like an aerodynamic spike, and thus is named “aerospike”. The choice of spike length is a tradeoff between weight and efficiency.

A preferred embodiment of an aerospike according to the invention is partially cut off or truncated. This reduces the weight with a modest decrease in efficiency. The length of the spike and amount of truncation depends on the base pressure, i.e. pressure generated by the exhaust flow over the base, and the timing or transition of the closed wake from exhaust flow.

Portions of the exhaust control spike 540, such as the spike rod and throat insert can be manufactured out of graphite.

As shown in the conceptual drawing of FIG. 9, an embodiment of an aerospike engine system having an annular aerospike, such as those shown in FIG. 5B and FIG. 6, is provided with a plurality of thrusters 530 surrounding the aerospike 540 and turbine exhaust aperture wherein the exhaust from the plurality of thrusters 530 meet with an exhaust 650 from a turbine system 570 at the base 610 of the aerospike. As there is no outer boundary, the atmospheric pressure acts as an outer boundary constraining the gas jet exhaust.

In other words, the nozzle ramp of the aerospike nozzle is equivalent to the bell nozzle's inner wall and atmospheric pressure acts as the outer wall. The combustion gasses parallel to the nozzle ramp and the atmospheric pressure work together to produce thrust. The efficiency behind the aerospike nozzle is in that the exhaust recirculating near the base of the spike raises the pressure in that area to almost equivalent of the surrounding pressure. As a result, the exhaust virtually offsets the aerodynamic forces acting on the rocket, thus the rocket does not lose thrust. Accordingly, one embodiment of the invention provides that the toroidal set of nozzles 550, or cell nozzles, form an exterior combustion region 940 without an enclosed combustion chamber as shown in the conceptual diagram of FIG. 9.

As shown in FIG. 10, each of the plurality of thrusters 530 is provided with an asymmetrical conical or contoured nozzle 550 having an exhaust aperture 535 a throat 555, and a combustion chamber 560. The dimensions of the throat of the nozzle of the thruster are adapted to accommodate high pressure and flow rate of a solid motor. Preferably, optimal aerospike nozzle parameters can be provided for isentropic, inviscid and irrotational supersonic flows for any user-defined exit Mach number and mass flow rate.

With reference to an embodiment of the invention as shown in FIG. 5, the annular aerospike is provided having such clustered cell nozzles of the thrusters 530 place proximate to one another with each exhaust aperture 535 directed towards the aerospike. Problems faced by such a design include complicated flow field, and gaps which create performance losses, as well as interaction of differential expansion of adjacent jets.

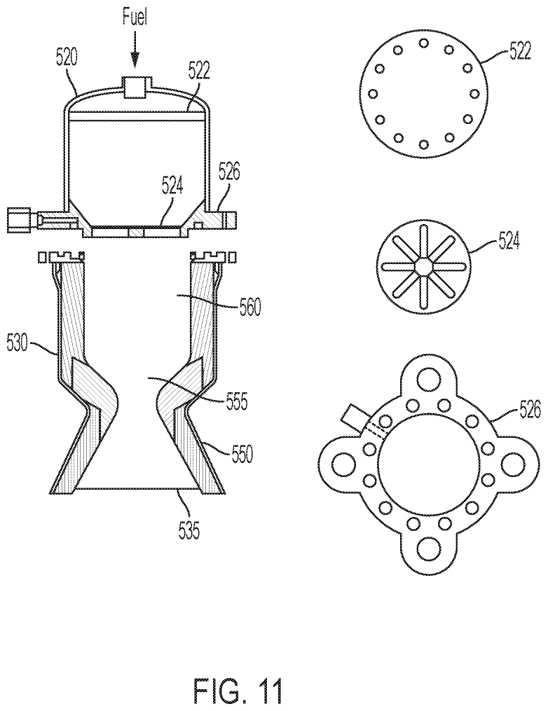

FIG. 11 shows a cross-section of the thruster section 530 connected to a catalyst system 520. As described above with respect to FIG. 11, a thruster section 530 includes at one end a region for receiving combustion materials, and at a second end, directing the combustion materials to the exhaust aperture 535 and to the exhaust control spike 540 in combination with other thrusters 530.

The design of the cell nozzle affects the performance of the engine. The throat of the cell nozzle should be such that it boosts the velocity of the flow to a sonic speed, and thereafter expansion further increases its velocity. Heat load of the throat area can be significant. The exit of the cell nozzle should contour to permit the flow exiting to flow smoothly over the surface of the aerospike by without creating disturbance and or eddies. In addition, the gaps between the cell nozzles should be maintained at a minimum to avoid turbulence and differential effects. In one embodiment, the cell nozzles are preferably fabricated with titanium (TI-6-4) and cobalt chromium alloy (Co28Cr6Mo). Other portions of the cell nozzles and injectors of the catalyst system 520 can be made of aluminum alloy and an outer combustion chamber can be provided with steel and lined with an ablated liner made out of silk fibers, phenolic resin, and or phenolic glass. Additionally, the thruster can include silico/phenolic ablative liner.

An aerospike engine according to the invention includes a catalyst system such as shown in FIG. 11. The catalyst system includes means for receiving a fuel and combining the fuel with one or more catalysts. The catalyst system 520 can include one or more flow constriction means 1220, including a spreader plate 522, orifice plate 524, and a thrust ring 526.

A spreader plate 522 can be provided to distribute fuel that has been received by the catalyst system to areas of the catalyst system containing one or more catalysts. One embodiment of a spreader plate according to the invention is a solid plate having a pattern of apertures extending through the plate through which the fuel and or fuel catalyst combination can pass. For example, the spreader plate can have a repeating pattern of hundred 28 holes of 0.065 diameter mm evenly spread around the perimeter or within a grid. The orifice plate 524 can be provided to create a convergent-divergent section within the catalyst system. In one embodiment, the orifice plate is provided as a solid plate having several apertures therethrough, which apertures are arranged radially from the center of the orifice plate and have an elongated form. Accordingly the orifice plate provides a means of constricting flow of the fuel catalyst mixture as an expanding gas, and passing that mixture through the apertures to a divergent region following the orifice plate. The thrust ring 526 is provided for further directing the resulting expanding gas and fuel-catalyst mixture to a combustion chamber 560, and for connecting the catalyst system 520 to the thruster 530.

It can be appreciated by person of ordinary skill in the art that various embodiments of the invention can be provided where one or more of the flow constriction means can be disposed in different areas. For example, in one embodiment shown in FIG. 11, a spreader plate can be disposed at a top portion of the catalyst system 520 at a region where the catalyst system receives a fuel source. The orifice plate 524 can be provided near or at a bottom portion of the catalyst system, and the thrust ring can be provided after the orifice place and at a bottom portion of the catalyst system.

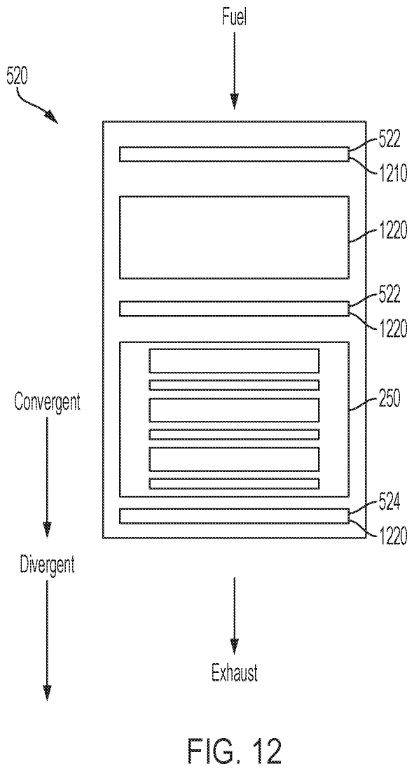

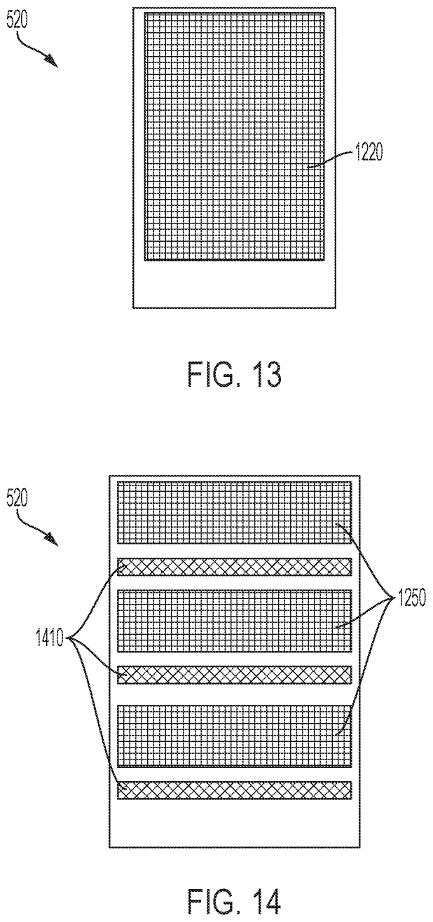

FIG. 12 shows a further embodiment of a catalyst system 520 in accordance with the invention. In this embodiment, the catalyst system includes one or more catalysts. A first catalyst 1220 can be provided as a booster catalyst. In one embodiment the first catalyst is provided as a monolithic alumina foam (aluminum oxide) impregnated with potassium permanganate. This system allows for a single monolithic catalyst without integrity screens.

A second catalyst 1250 can be provided as the primary catalyst for combusting with the fuel, such as being composed primarily of aluminum oxide ceramic pellets saturated with potassium permanganate (sintered). The ceramic pellets are then baked to imbed the potassium permanganate in the alumina matrix. If multiple layers of these sintered pellets are provided, at least one screen made from stainless steel can be provided to maintain the integrity of the layers of pellets. Such an embodiment can be described as a bi-propellant hydrogen peroxide-hydrocarbon aerospike engine.

An additional catalyst can also be provided, such as shown in FIG. 12. Where more than one catalyst is provided, the catalyst system also includes at least one separator means 1210 to ensure the integrity of each catalyst inside the catalyst container of the catalyst system 520. In one embodiment of the invention, the separator means 1210 are provided as a stainless steel screen 1410. Alternatively a spreader plate or orifice plate can be used to separate the first catalyst from the second catalyst.

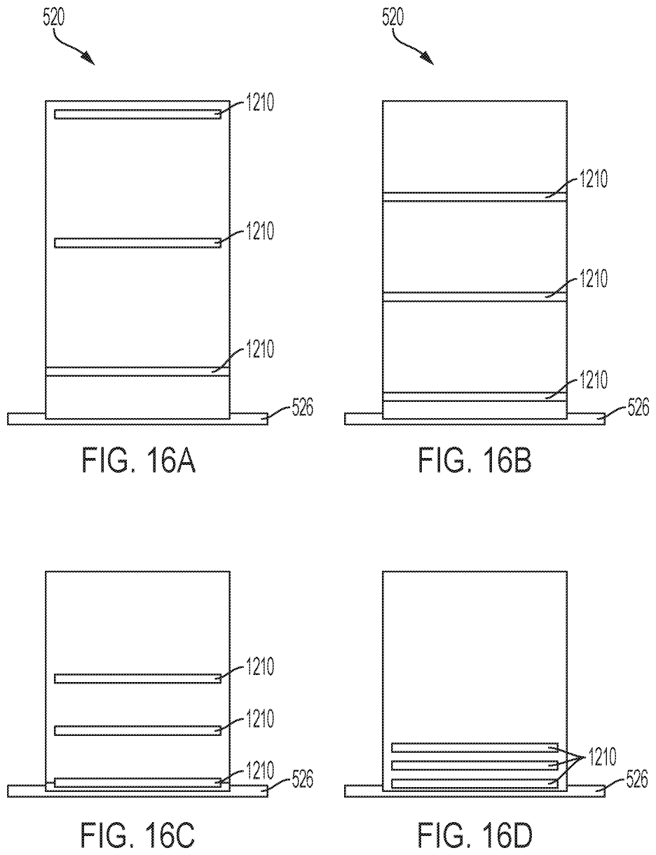

The combined use of separator means—including spreader plate, orifice plate, thrust ring and/or stainless steel screens—can be provided not only for separating various catalyst in the catalyst system, but can also provide flexibility of design of the catalyst system 520 to obtain the benefit of convergent and divergent regions of combustion within the catalyst system 520 and exhaust to the combustion chamber 560 of the thruster. The fuel and catalyst mixture control system 580 and intermediate catalyst control system 590 can be used to implement a variety of controlled combustion's within the thruster unit. Various combinations of one or more embodiments according to the invention are shown in FIG. 16a-d, wherein one or more catalysts can be separated with one or more spreader plates or separator means 1210 into different regions of the catalyst system 520, thereby providing modifiable convergent and divergent regions which can be controlled by the fuel and catalyst mixture control system 580 and intermediate catalyst control system 590.

In one embodiment of the invention, the fuel introduced to the catalyst system can be pressure fed. However, it can be appreciated that a gas generator cycle can be provided for such purpose, which is a power cycle of a bi-propellant rocket engine, whereby some of the propellant is burned in a gas generator and the resulting hot gas is used for a turbine system 570 or to power the engines pumps while the gas is then exhausted.

The fuels enter the combustion chambers, whereupon the combination is ignited and combustion occurs and the resultant hot gas then pass through the aerospike nozzle to produce thrust.

An embodiment of an aerospike engine according to the invention can be adapted for other fuel types. In a further embodiment of aerospike rocket engine uses two catalysts for the aerospike engine chambers, namely a primary fuel such as liquid hydrogen and a primary oxidizer such as liquid oxygen. Alternatively, other fuels that can be used include methane and peroxide or kerosene. For example, in a further embodiment, the primary oxidizer can be fed from a peroxide generator, and the catalyst system, described above, adapted for this purpose.

For both catalysts, other catalytic material could be used in place of potassium permanganate. This includes manganese dioxide, palladium or silver oxide among others.

In a further embodiment, a fuel can be introduced to the combustion chamber 560 at a point after the catalyst system 520. In such a variation, as the hot gas enters the combustion chamber, it ignites automatically the hydro-carbon fuel without the need of an ignitor.

Referring to the drawing, FIG. 15, depicts a further embodiment of the aerospike engine according to the invention having a thruster 530 adapted for use with a turbine engine 570 and turbine power system 575. This further embodiment can be adapted for use with larger aircraft that can carry larger tanks of fuel. While less efficient as liquid hydrogen/liquid oxygen fuel, the chosen fuels of liquid oxygen and methane are less dense and less reactive with containing tanks. Alternatively, a commendation of catalyst such as per potassium permanganate described above can be used. Accordingly, such further embodiment may find use with single stage to orbit vehicles and reusable craft. Furthermore, a variety of fuel choices are permitted allowing for vehicles intended for multiple daily use in daily use of the craft.

Specifically, as shown in FIG. 15, one such design includes having a liquid oxygen and methane fuel sources, having a preferred nozzle design, namely an annular conical isentropic truncated aerospike nozzle. The particular design of this engine can also include bleed compensation for a single stage.

This type of engine design preferably realizes a maximum of 30,000 pounds (133,447 N) thrust, is throttable to two percent thrust, and can be adapted for shut down and restart which can be an important design consideration for the vehicle and is intended purposes.

Other systems for optional inclusion with an embodiment of the invention, include the intermediate catalyst control system 590, the fuel and catalyst mixture control system 580, and the turbine system 570 shown in FIG. 5.

The intermediate catalyst control system 590 provides means for introducing fuel at a regulated rate at one or more sections of the catalyst system 520. For example, in addition to the catalyst system 520 having means for receiving fuel at a top portion, such as a pressure fed valve and/or pump system, the catalyst system 520 can include one or more apertures on the side the system which can provide distribution of fuel at intermediate areas within the catalyst system, such as the spreader plate 522 would do at a top portion of the catalyst system.

The fuel and catalyst mixture control system 510 provides means for control of the flow of fuel and catalyst, which a person of ordinary skill in the art would appreciate the use of electromechanical utilize contemporary electronic and mechanical systems. Specifically, the fuel and catalyst mixture control system can provide to start, throttling and shutdown of fuel entering the catalyst system in one embodiment, or alternatively or in addition the start, throttling, and shutdown of the fuel and catalyst mixture exhausting from the catalyst system 520 into each thruster's combustion chamber, and thus control each thruster individually.

In addition, the fuel and catalyst mixer control system 580 can provide or shunting of exhaust gas from either a separate exhaust from the catalyst system to power the turbine system 570, or for controlling a separate turbine system 574 use in conjunction with the aerospike engine. It can be appreciated by a port a person of ordinary skill in the art that contemporary turbine or turbo fan systems can be adapted for use with an embodiment aerospike engine according to the invention as described herein.

Shut down and restart capability of an engine is important for engine design for orientation and or to change, as well being useful for continuous flight and maneuverability. An engine that has multiple chambers that are individually throttleable can permit thrust vectoring while also being more efficient in space travel. For example, such an engine is useful to provide a vehicle that cannot only deliver payload but turn, orient, deorbit, as well as reenter the atmosphere on the land. The above engine design provides use with fuels such as peroxide, kerosene, and potassium permanganate among others.

The fuels adaptable for engines that are potentially runway safe can be adapted utilizing existing commercial airline technology, wherein alternative embodiments of the existing invention can be designed having a scale to replace conventional turbo fan engines.

FIGS. 16a-d illustrate various combinations of one or more embodiments of the catalyst system according to the invention shown in FIG. 12, wherein one or more catalysts can be separated with one or more spreader plates or separator means 1210 into different regions of the catalyst system 520, thereby providing modifiable convergent and divergent regions which can be controlled by the fuel and catalyst mixture control system 580 and intermediate catalyst control system 590, and thereby provide greater control of input pressure for the combustion chamber 560.

Additional fuel distribution and control components can be provided in alternative embodiments of the invention. The fuel and catalyst mixture system 580 provides one or more means of introducing fuel into the catalyst system, either at a top portion (as described above) or into intermediate sections of the catalyst system. In addition, the intermediate catalyst control system 590 can provide means for effectively mixing fuel and catalyst in a predetermined sequence, controlling the fuel and catalyst mixture system 580. It can be appreciated by persons of ordinary skill in the art that electrical, hydraulic, valves and fuel lines can be provided for the above-described intermediate catalyst control systems and catalyst mixture system.

Aspects of the embodiments described herein can be modified within the scope of the invention in order to adapt an embodiment of the aerospike engine to suit different purposes and under different conditions.

Various changes may be made to the system and process embodying the principles of the invention. The foregoing embodiments are set forth in an illustrative and not in a limiting sense. The scope of the invention is defined by the claims appended hereto.

I/We claim:

1. An aerospike rocket engine system comprising:
an exhaust control spike,
a plurality of thrusters arranged in an annular ring, wherein each of said thrusters comprise at least one combustion chamber having an exhaust aperture disposed proximate to the exhaust control spike, and whereby each exhaust aperture of said plurality of thrusters are arranged an annular ring around said exhaust control spike,
at least one fuel system,
at least one catalyst system operatively connected to said fuel system for receiving a fuel, and wherein said catalyst system is disposed proximate to at least one combustion chamber, and is operatively connected to the combustion chamber, and
a fuel and catalyst control system operatively connected to said fuel system and said catalyst system for controlling flow of a fuel and a catalyst.

2. An aerospike rocket engine according to claim 1
wherein said exhaust control spike is truncated.

3. An aerospike rocket engine according to claim 1 further comprising:
a turbine engine, and wherein the exhaust, control spike is conical and further comprises an aperture disposed axially from a first end to an exhaust end of said exhaust control spike, wherein the first end is disposed proximate to said turbine engine for receiving an exhaust therefrom.

4. An aerospike rocket engine according to claim 1 wherein said aerospike is conical.

5. An aerospike rocket engine according to claim 1 wherein said plurality of cell nozzles are clustered.

6. An aerospike rocket engine according to claim 1 wherein exhaust control spike comprised of titanium (TI-6-4) and cobalt chromium alloy (Co28Cr6Mo).

7. An aerospike rocket engine according to claim 1 wherein said catalyst system includes at least one catalyst and at least one separator means.

8. An aerospike rocket engine according to claim 7 wherein said at least one flow constrictor means is selected from the group consisting of a spreader plate, and orifice plate, a thrust ring, and a stainless steel screen.

9. An aerospike rocket engine according to claim 1 wherein said catalyst system includes a first catalyst and a second catalyst, and an orifice plate adapted for providing a convergent region and divergent region, wherein said convergent region is disposed within the catalyst system, and said divergent region is disposed proximate to said combustion chamber.

10. An aerospike rocket engine according to claim 9 wherein said first catalyst is comprised of alumina foam is impregnated with potassium permanganate and said second catalyst comprised of sintered ceramic pellets impregnated with potassium permanganate.

11. An aerospike rocket engine according to claim 1 wherein said catalyst system includes a spreader plate, a first catalyst, a second catalyst, and an orifice plate; wherein said spreader plate includes a plurality of apertures and is adapted for separating a flow of fuel introduced on a proximal side of said spreader plate from said first catalyst at a distal side of said spreader plate, and wherein said apertures spread said fuel over said first catalyst, and
wherein said orifice plate includes at least one orifice aperture adapted to provide a convergent region at a proximal side of said orifice plate and a divergent region at a distal side of said orifice plate whereby a combustion of said first and second catalyst with said fuel flows through said at least one orifice aperture.

12. An aerospike rocket engine according to claim 1 further comprising fuel and catalyst control system operatively connected to said fuel system whereby each thruster is individually throttleable.
